(19) United States
(12) Patent Application Publication
(10) Pub. No.: US 2024/0375464 A1
(43) Pub. Date: Nov. 14, 2024

(54) HITCH SYSTEM, VEHICLE EQUIPPED WITH SUCH A SYSTEM, ASSEMBLY KIT AND CORRESPONDING METHODS FOR ASSEMBLY, OPERATION AND USE

(71) Applicant: GEA FARM TECHNOLOGIES CANADA INC., Drummondville, Quebec (CA)

(72) Inventor: Alain COURTEMANCHE, Lefebvre, Quebec (CA)

(73) Assignee: GEA FARM TECHNOLOGIES CANADA INC., Drummondville, Quebec (CA)

(21) Appl. No.: 18/684,540

(22) PCT Filed: Aug. 16, 2022
(86) PCT No.: PCT/CA2022/051243

§ 371 Date: Feb. 16, 2024

(30) Foreign Application Priority Data
Aug. 16, 2021 (CA) 3128326

(51) Int. Cl. B60D 1/24; B60D 1/02

(52) U.S. Cl. CPC B60D 1/249; B60D 1/02

(57) ABSTRACT

A coupling system includes three axes to enable a trailer to be articulated in all directions when the trailer is hitched to a towing vehicle, such as a tractor. The pitch axis, which is either centered with the other two axes or is offset towards the tractor, limits the forces transmitted to the tractor drawbar in the case of a high vertical load. Thus, the coupling system with three offset axes provides the fundamental advantages of a universal joint but, by offsetting the pitch axis forward, the coupling system particularly and advantageously provides an additional and innovative solution whereby large vertical loads from certain machines towed on the tractor drawbar can be better withstood.

### CROSS-REFERENCE TO RELATED APPLICATIONS

The present application is a National Stage Filing of PCT International Patent Application No. PCT/CA2022/051243, filed Aug. 16, 2022, which claims the benefit of priority to Application No. 3128326, filed Aug. 16, 2021 in Canada of which both applications are incorporated herein by reference in their entireties.

### FIELD OF THE INVENTION

The present invention relates to the field of coupling devices, as used in the field of towing and/or agriculture (ex. coupling between a tractor and a towed vehicle, etc.) and/or for any other type related application. More particularly, the present invention relates to a novel hitch system for hitching a towing vehicle (ex. a tractor, etc.) to a towed vehicle (ex. a trailer, a spreader, etc.), and also relates to a vehicle (ex. traction vehicle and/or a trailed vehicle) and/or an arrangement of such vehicles provided with such equipment, as well as a kit intended to assemble it (them), and methods of assembling, operating and/or use associated thereto.

### DESCRIPTION OF THE PRIOR ART

It is known in the art that the coupling between an agricultural tractor and a trailed machine is carried out on the drawbar of the tractor. The trailed machine must be able to pivot in all directions to ensure pitch, yaw and roll.

Traditional hitches generally consist of a double drawbar on the tractor, a single bar on the machine and a rod connecting the two parts. In such a hitch design, pitching and rolling are ensured by providing sufficient clearance between the rod and the single hitch bar.

The problem with this type of hitch is that as the size of the hitch increases, the clearance between the parts also increases. This bigger game causes heavy blows when braking and accelerating, especially for larger couplings with a higher vertical load and total loaded mass. Tractor drawbar sizes are defined in ANSI/ASABE AD6489-3. Previously there were 3 categories but tractor manufacturers are producing more and more powerful tractors and drawbars are now available up to size or category 5. With this rise in power the industry has seen an evolution coupling modes in order to reduce the excessive play caused by the oversizing of the components.

Also known in the art is the ball type solution. In fact, in order to reduce play to a minimum, ball-type hitches are frequently used. But this solution is again better suited to smaller hitches with a lower load. Category 4 and 5 tractors allow higher loads than the balls available on the market are capable of withstanding. When a ball-type hitch is used in these conditions, component wear becomes an issue.

Also known in the art is the problem associated with the two (2) aforementioned hitch types (i.e. traditional solution and ball-type solution). Indeed, these two (2) types of coupling are sometimes incompatible with certain types of servo-steering system of trailed machines. These power steering systems are composed of mechanisms attached to the tractor in various ways and mechanically transmit the movement of the tractor, relative to the trailed machine, to a hydraulic power steering system in order to induce a deflection to the steering axles of the trailed machine so that it follows the tractor. These types of hitches usually leave very little room to add these mechanisms. The space between the top of the hitch components and the bottom of the power transmission shaft is too often insufficient. Also known in the art is the universal joint type solution. Indeed, the universal joint type coupling is composed of 3 axes. Each axis provides motion in one direction, namely pitch, yaw and roll. The combination of these 3 axes allows completely free movement in all directions.

This alternative requires removing the upper part of the tractor drawbar. The double part is then on the trailed machine. This allows better integration of mechanical elements that can be used to transmit movement to a power steering system since the free space between the hitch and the power transmission shaft is increased.

This type of hitch is, once again, better suited for smaller loads since the axis providing the pitch is offset to the rear. This induces considerable efforts on the mechanical parts when the vertical load is high. Tractor-side drawbars are subjected to higher forces than they were designed for. This solution has been commonly used for several years for light trailers or for agricultural equipment with minimal vertical load but should not be used for heavy load trailers such as slurry spreaders.

Therefore, it would be greatly beneficial to find a new technique/approach and/or hitch system/equipment to connect a towing vehicle (ex. tractor, etc.) to a towed vehicle (ex. trailer, a spreader, etc.), for example, and to be able to overcome and/or reduce/minimize, some of the disadvantages and disadvantages mentioned above, and/or at least to be able to do so in a faster, simpler, more precise, more efficient, more economical, more reliable, more tunable, more versatile, more adaptable, more durable, more versatile, more desirable, and/or better than is possible with the current way of doing things.

### SUMMARY OF THE INVENTION

An object of the present invention is therefore to provide a hitch system (and/or a vehicle comprising such equipment, etc.) which, thanks to its design and its components, would satisfy some of the aforementioned needs and would therefore be an improvement over compared to other ways of doing, systems and/or related hitching methods known in the prior art.

The aforementioned object is achieved, as will be better understood hereinbelow, by a hitch system (and/or a vehicle comprising such equipment, etc.) such as that briefly described in the present description, and such as that exemplified in the attached figures.

More particularly, and according to a possible embodiment of the present invention, the latter relates in particular to a coupling system, for coupling a traction vehicle to a trailed vehicle being pulled by the traction vehicle, the coupling system comprising:
a main connection assembly defining a longitudinal cavity being positioned, shaped and sized to receive a portion of a drawbar of the traction vehicle;
a pitch adjustment assembly being operatively mounted to the main connection assembly, and being able to adjust in angle relative to said main connection assembly by pivoting about a first axis (A) of rotation;
a yaw adjustment assembly being operatively mounted to the main connection assembly, and being adapted to adjust in angle relative to said main connection assembly by pivoting about a second axis (B) of rotation; and
a roll adjustment assembly being operatively mounted to the pitch adjustment assembly, and being adapted to adjust in angle relative to said pitch adjustment assembly by pivoting about a third axis (C) rotation;
wherein the first axis (A) of rotation is positioned upstream of the second axis (B) of rotation, namely on the side of the traction vehicle.

According to another aspect of the present invention, the latter also relates to a corresponding vehicle (ex. traction vehicle and/or a trailed vehicle) provided with the aforementioned system and/or equipment.

According to another aspect of the present invention, the latter also relates to an arrangement of such corresponding vehicles (ex. traction vehicle and/or trailed vehicle) provided with the aforementioned system and/or equipment.

According to another aspect of the present invention, it also relates to a kit with corresponding components for assembling the aforementioned system, equipment, vehicle and/or arrangement.

According to another aspect of the present invention, the latter also relates to a method of assembling components of the aforementioned system, equipment, vehicle and/or arrangement.

According to another aspect of the present invention, the latter also relates to a method of operating the aforementioned system, equipment, vehicle and/or arrangement, and/or certain components thereof. this.

According to another aspect of the present invention, the latter also relates to a method of using the aforementioned system, equipment, vehicle and/or arrangement, and/or certain components thereof. this.

According to another aspect of the present invention, the latter also relates to a set of components to be interchanged on the aforementioned system, equipment, vehicle and/or arrangement.

According to another aspect of the present invention, the latter also relates to a method of manufacturing one or other of the components of the aforementioned system, equipment, vehicle and/or arrangement.

According to another aspect of the present invention, the latter also relates to land (and/or the harvest thereof, etc.) having been treated with the system, the equipment, the vehicle, the layout, the kit, and/or the aforementioned method(s).

According to another aspect of the present invention, it is also directed to a method of doing business with the system, equipment, vehicle, arrangement, kit, method(s), game and/or the aforementioned product).

The objects, advantages, and other characteristics of the present invention will become more apparent on reading the non-limiting description which follows of the preferred embodiments of the invention, shown in the attached drawings, and given by way of example. only.

Indeed, the attached figures illustrate various components, characteristics, variants and/or possible combinations, of various aspects of the coupling system, according to various possible non-limiting embodiments of the present invention.

### BRIEF DESCRIPTION OF THE ACCOMPANYING DRAWINGS

FIG. 1 is a schematic representation of a conventional coupling device used to connect a towing vehicle (ex. a tractor) to a towed vehicle (ex. a trailer) according to the prior art.

FIG. 2 is an enlarged view of the conventional hitch device such as that shown in FIG. 1.

FIG. 3 is an enlarged view of a conventional ball-type coupling device according to the prior art.

FIG. 4 is a photo schematically representing problems inherent in the design of a conventional coupling device of the universal joint type according to the prior art.

FIG. 5 is a top perspective view of a hitch system having a coupling device having corresponding male and female components according to one possible embodiment of the present invention, the hitch system being shown in cooperating with part of a swivel shaft (representing a towed vehicle) being shown exploded and with part of a straight drawbar (representing a traction vehicle).

FIG. 6 is another top perspective view of what is shown in FIG. 5, the pivoting shaft (depicting a towed vehicle) now being shown connected to the hitch system according to one possible embodiment of the present invention.

FIG. 7 is a longitudinal sectional view of what is shown in FIG. 6.

FIG. 8 is another sectional view of what is shown in FIG. 7.

FIG. 9 is another cross-sectional view of what is shown in FIG. 8, the hitch system now being shown in an example of “pitching” (ex. bumps and dips in the roadway when moving the vehicle, etc.) according to a possible embodiment of the present invention.

FIG. 10 is another top perspective view of what is shown in FIG. 6, with the hitch system now shown in an exemplary “neutral” position according to one possible embodiment of the present invention.

FIG. 11 is another top perspective view of what is shown in FIG. 10, with the hitch system now shown in an example of a “yaw” according to one possible embodiment of the present invention.

FIG. 12 is an enlarged view of what is illustrated in FIG. 10, the hitch system being again shown in an example of a “neutral” position according to one possible embodiment of the present invention.

FIG. 13 is another top perspective view of what is shown in FIG. 10, the hitch system now being shown in an example of “pitch” (ex. up) according to one possible embodiment of the present invention.

FIG. 14 is another top perspective view of that shown in FIG. 10, the hitch system now being shown in an example of “pitch” (ex. down) according to one possible embodiment of the present invention.

FIG. 15 is a top perspective view of a hitch system having a coupling device having first and second clamping components according to one possible embodiment of the present invention, the hitch system being shown cooperating with part of a pivoting shaft (representing a towed vehicle) and with part of a curved drawbar (representing a traction vehicle).

FIG. 16 is an enlarged view of a portion of what is shown in FIG. 15.

FIG. 17 is another top perspective view of what is shown in FIG. 15.

FIG. 18 is a bottom perspective view of what is shown in FIG. 17.

FIG. 19 is a right side view of what is shown in FIG. 17.

FIG. 20 is a left side view of what is shown in FIG. 17.

FIG. 21 is a top view of what is shown in FIG. 17.

FIG. 22 is a bottom view of what is shown in FIG. 17.

FIG. 23 is a rear view of what is shown in FIG. 17.

FIG. 24 is a front view of what is shown in FIG. 17.

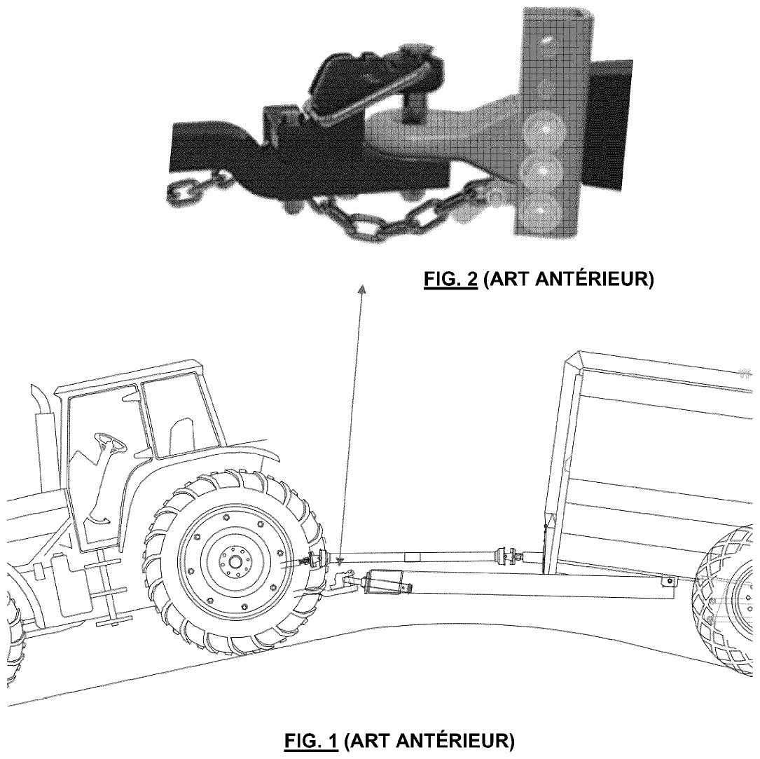

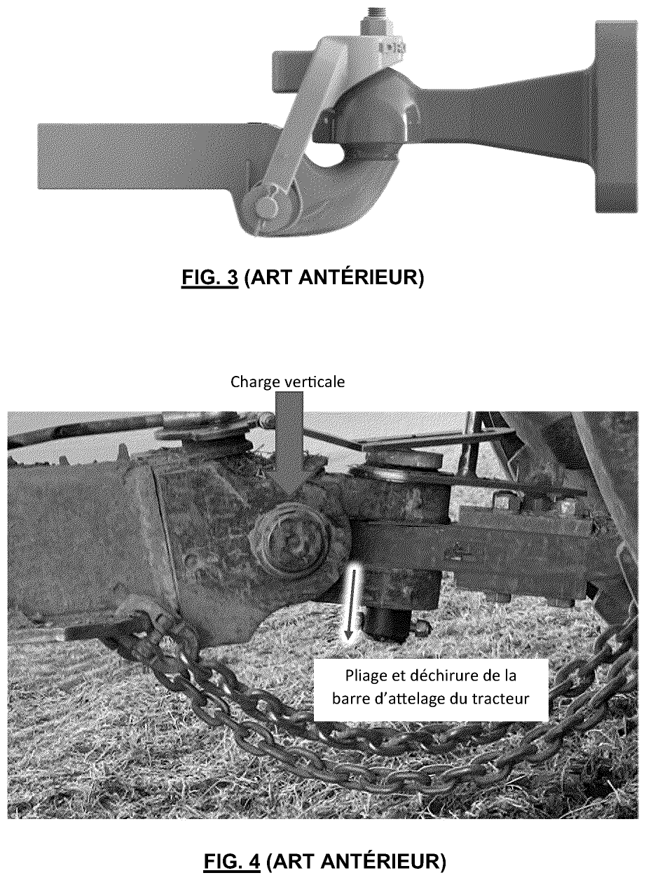

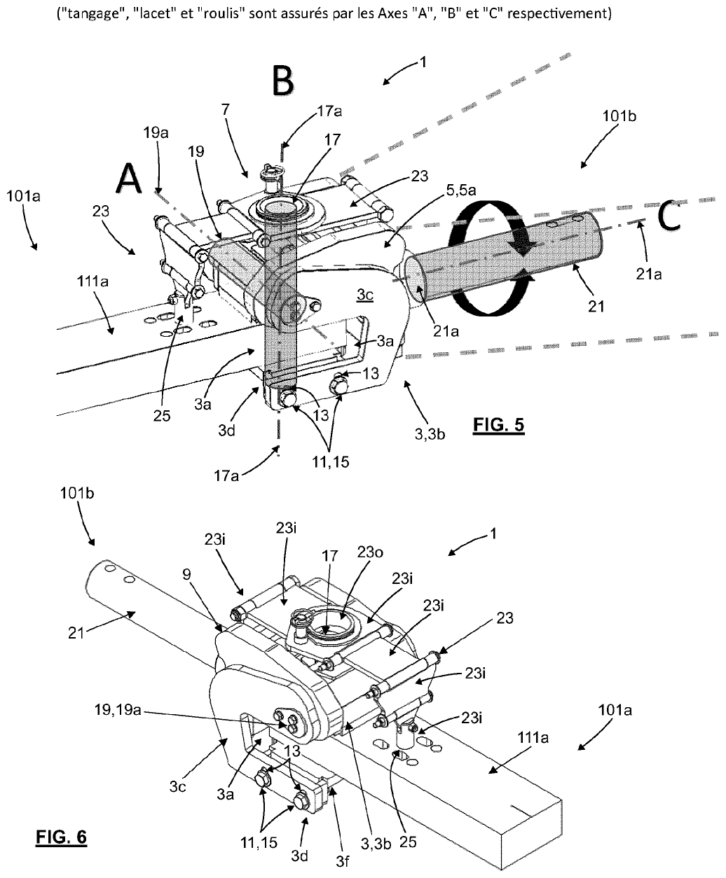

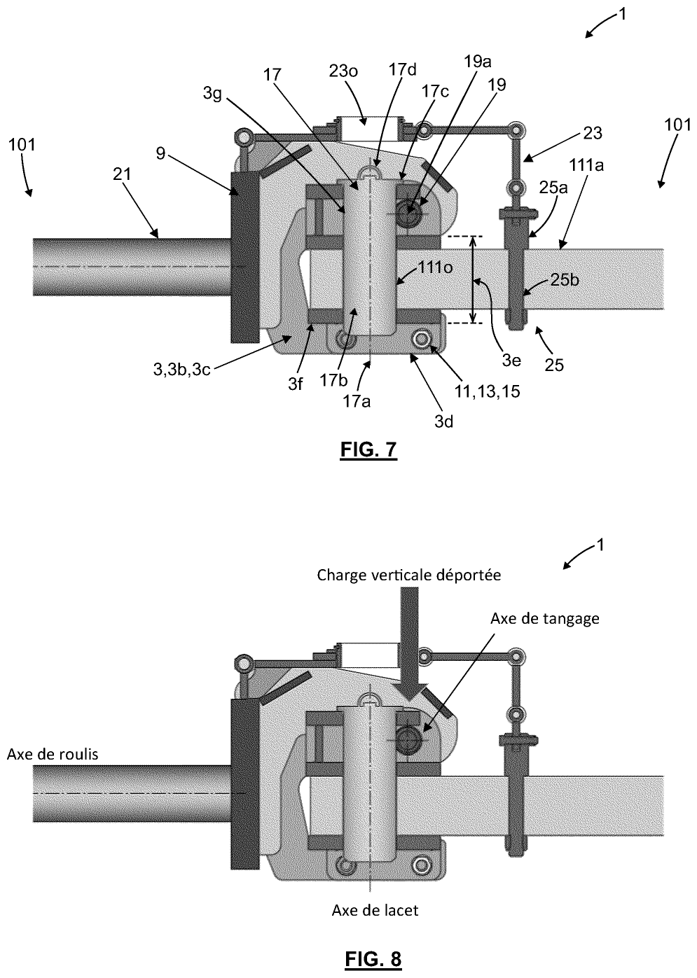

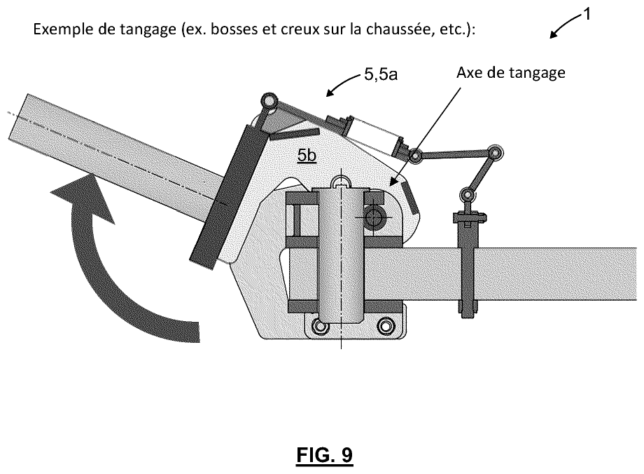

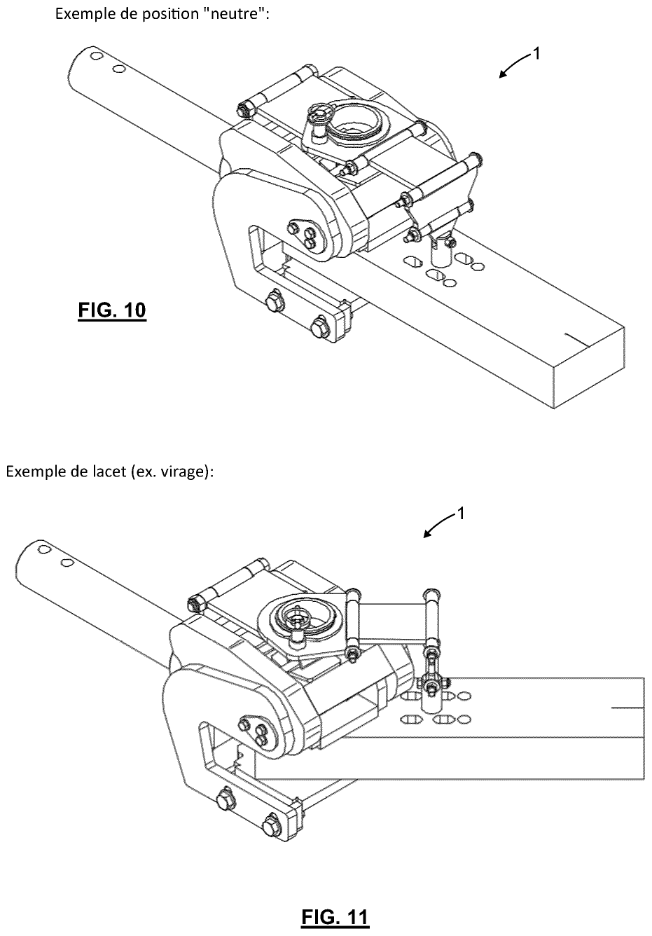

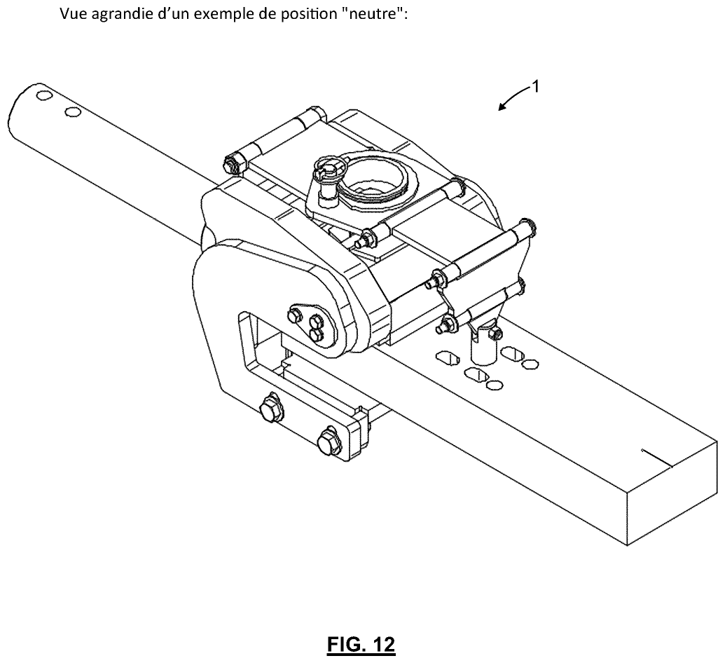

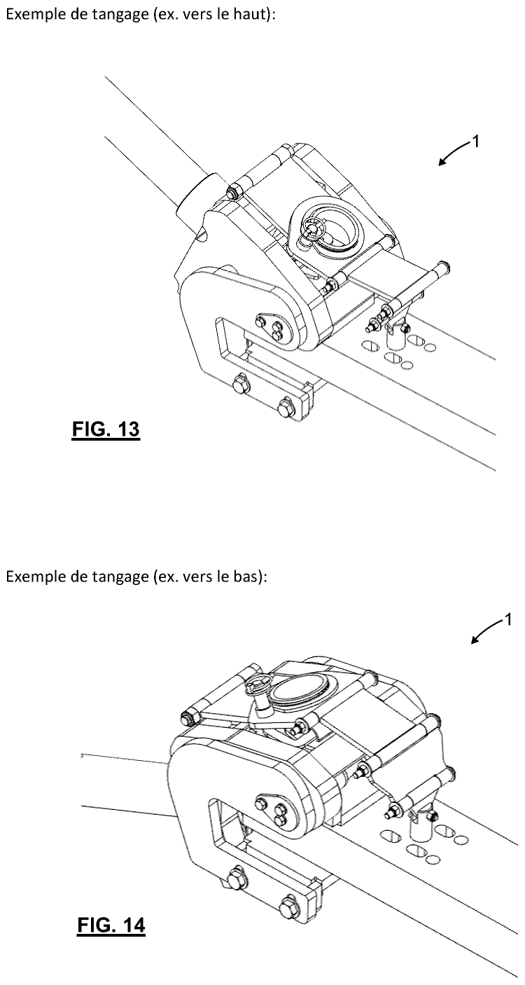

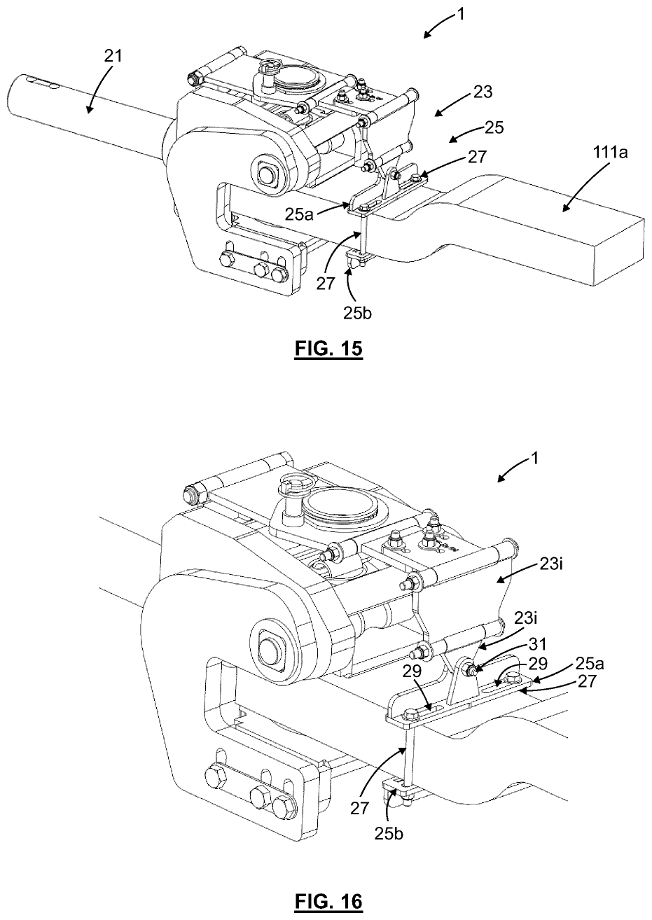

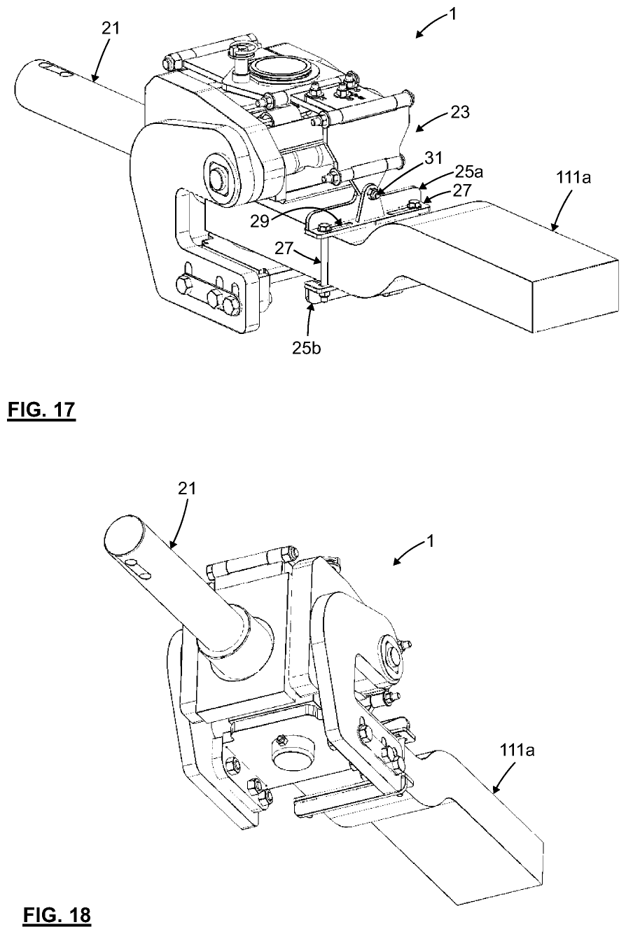

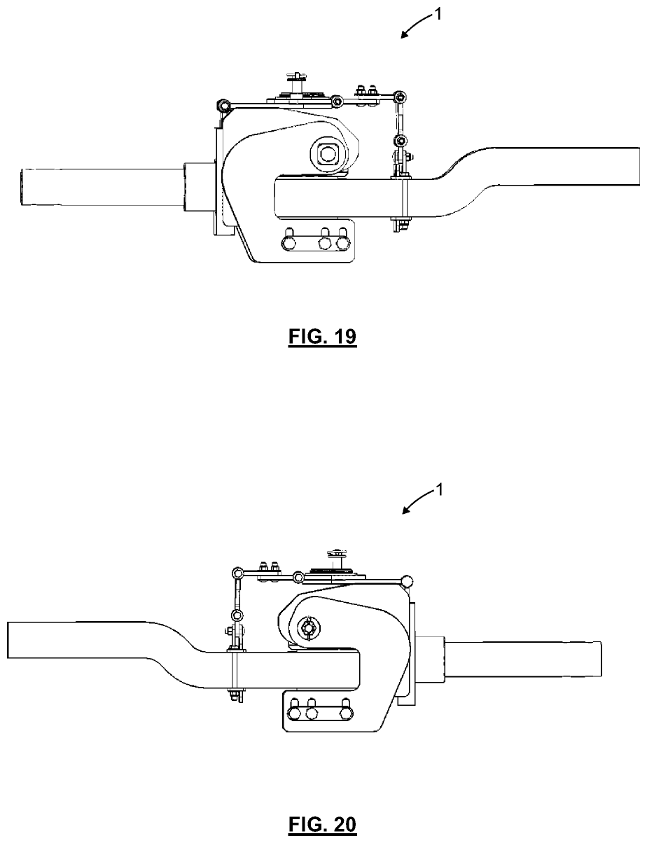

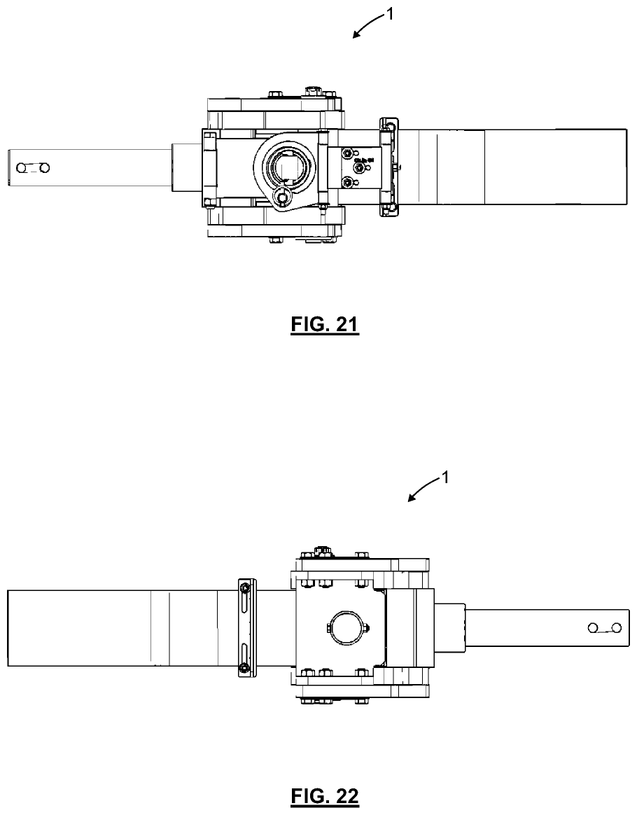

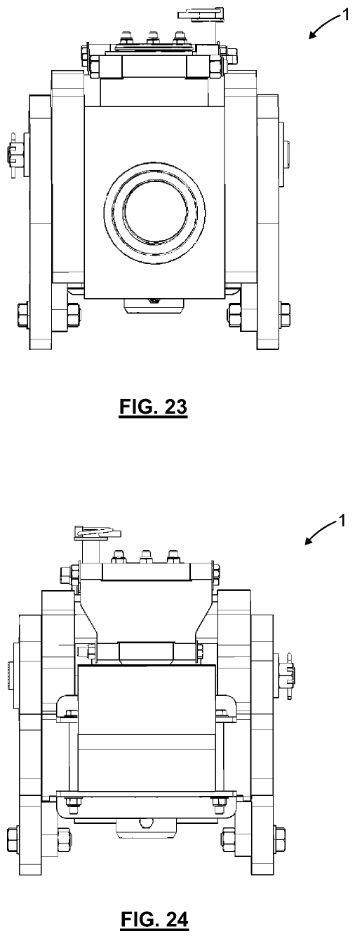

### DESCRIPTION OF PREFERRED EMBODIMENTS OF THE INVENTION

In the following description, like reference numerals refer to like components. The embodiments (geometries, dimensions, etc.) illustrated in the figures and the characteristics described in the application are preferential only, given as an indication only.

Additionally, although the present invention is designed primarily as a hitch system for connecting a pulling vehicle (ex. tractor, etc.) to a towed vehicle (ex. trailer, spreader, etc.), in a context of agriculture, for example, the invention could be used with any other type of joints and/or for any other type of application and/or useful purpose, as obvious to a person skilled in the art. Therefore, terms such as “hitch”, “vehicle”, “pulling”, “towed”, “agriculture”, “tractor”, “trailer”, “spreader”, etc., as used herein, and/or any other reference and/or other expression equivalent or similar thereto shall not be construed as limiting the scope of the present invention and include any other object/substitute and/or any other application with which the present invention may be used and may be useful, as obvious to one skilled in the art.

Furthermore, although the preferred embodiments of the illustrated system comprise several components, all these components are not necessarily essential to the invention and consequently should not be taken in their restrictive sense, that is to say should not not be considered to limit the scope of the present invention. It is to be understood therein, as obvious to a person skilled in the art, that other suitable components and geometries and/or other possible cooperations therebetween can be used for the system according to the present invention, as they will be described below, without departing from the scope of the invention.

Also, expressions such as “system”, “equipment”, “hitch”, “coupling”, “joint”, “connection”, “connector”, “kit”, “device”, “assembly”, “mechanism”, “product”, “device”, “operator”, “controller”, etc., as well as any other equivalent expression and/or words composed of these, may be used interchangeably in the context of this description, as evident to a person skilled in the art. This also applies for other expressions which are mutually equivalent, such as, for example: a) “couple”, “connect”, “articulate”, “tow”, “couple”, “anchor”, etc.; (b) “vehicle”, “tractor”, “trailer”, “spreader”, etc.; c) “controller”, “operator”, “robot”, “control”, “computer”, “circuit”, “hardware”, “software”, “software”, “mechanical component(s), electronic component(s), electronic(s) and/or computer(s), etc.; as well as any other mutually equivalent expressions, related to the aforementioned expressions and/or to any other structural and/or functional aspects of the present invention, as also obvious to a person skilled in the art.

Additionally, in the context of this description, all elongated objects should be considered to implicitly have a “longitudinal axis” and/or a “centerline”, such as the longitudinal axis of a rod, for example, or the centerline of a duct, and that expressions such as “connected” and “connectable”, or “swivelling” and “swivelable”, may be interchanged and are mutually equivalent, in that the present invention also relates to a kit with corresponding components for assembling a resulting equipment and/or system fully assembled and operational to implement the present method and/or obtain any resulting and/or derived product. In addition, certain components of this system and/or steps of this method (ex. coupling, etc.) being described in this specification may be modified, simplified, omitted and/or interchanged, without departing from the scope of the present invention, depending on the particular applications for which the present system is designed and/or intended, and also depending on the desired results, as briefly described herein and as also obvious to one skilled in the art.

### Overview of the New Approach Proposed Hereby

In general, the present invention, as illustrated in the attached figures, consists of a coupling mechanism comprising 3 axes to ensure the articulation, in all directions, of a trailer when it is hitched to a tractor. The axis providing pitching being either centered with the other two axes, or offset towards the tractor in order to limit the forces transmitted to the tractor drawbar in the event of a high vertical load.

The coupling arm with 3 offset axes therefore uses the operating principles of a universal joint but by offsetting the pitch axis forwards. This allows in particular and advantageously to better support the imposing vertical loads of certain machines trailed on the tractor drawbar.

Reading the following paragraphs, associated with the drawings, will make it possible to better understand how the announced advantages are associated with the technical novelties of the invention.

### List of Numerical References and/or of Corresponding Preferential Components Illustrated in the Accompanying Figures and/or Being Possible for the Present System

1. coupling system (ex. hitch system)
3. main connection assembly (of the coupling system)
3a. longitudinal cavity (of the main connection assembly)
3b main body (of the main connection assembly)
3c. support (of the main connection assembly)
3d. height adjustment sub-assembly (of the main connection assembly)
3rd. effective height (ex. within the longitudinal cavity)
3g. hole (ex. of an upper part of the main connecting assembly—ex. to receive connecting rod)
3f. height adjustment component (of the main connection assembly—ex. to receive a portion of the drawbar)
5. pitch adjustment assembly (of hitch system)
5a. main body (of the pitch adjustment assembly)
5b. arm (of the pitch adjustment assembly)
7. yaw adjustment assembly (of hitch system)
9. roll adjustment assembly (of hitch system)
11. fastener (ex. bolt, screw, rivet, etc.)
13. hole (ex. of the main connection assembly)
15. tightening device (of the fastener—ex. thread, nut, etc.)
17. connecting rod (of hitch system)
17a. longitudinal axis (of connecting rod)
17b. main body (of connecting rod)
17c. flange (of connecting rod)
17d. handle (of connecting rod)
19. pin (of hitch system)
19a. longitudinal axis (of the pin)
21. shaft (ex. swivel shaft of roll adjustment assembly)
21a. longitudinal axis (ex. of the swivel shaft)
23. power-steering accessory
23i. section(s) (of the power steering accessory)
23o. passage (of the power steering accessory—ex. for the connecting rod)
25. connecting device
25a. first component (of the coupling device—ex. male component and/or first clamping component)
25b. second component (of the coupling device—ex. female component and/or second clamping component)
27. spun component (for clamping component)
29. groove (ex. of the clamping component)
31. pivot axis (ex. for given component of connecting device)
101. vehicle
101a. traction vehicle (ex. tractor, etc.)
101b. towed vehicle (ex. trailer, spreader, etc.)
111a. drawbar (ex. of the towing vehicle)
111o. hole (ex. drawbar)
A. first axis of rotation (ex. for pitch adjustment)
B. second axis of rotation (ex. for yaw adjustment)
C. third axis of rotation (ex. for roll adjustment)

The present coupling system (1) (and the various inventive aspects thereof) may (may) materialize in various forms and/or expressions, comprising one and/or more of the following components and characteristics (and/or different combination(s) and/or permutation(s) thereof, given as preferred and/or optional embodiment(s) only:
i). A coupling system (1), for coupling a traction vehicle (101a) to a towed vehicle (101b) being pulled by the traction vehicle (101a), the coupling system (1) comprising:
a main connection main (3) defining a longitudinal cavity (3a) being positioned, shaped and sized to receive a portion of a drawbar (111a) of the traction vehicle (101a);
a pitch adjustment assembly (5) being operatively mounted to the main connection assembly (3), and being able to adjust in angle with respect to said main connection assembly (3) by pivoting about a first axis (A) of rotation;
a yaw adjustment assembly (7) being operatively mounted to the main connection assembly (3), and being able to adjust in angle with respect to said main connection assembly (3) by pivoting around a second axis (B) of rotation; and
a roll adjustment assembly (9) being operatively mounted to the pitch adjustment assembly (5), and being angle adjustable relative to said pitch adjustment assembly (5) by pivoting about a third axis (C) of rotation;
wherein the first axis (A) of rotation is positioned upstream of the second axis (B) of rotation, namely on the side of the traction vehicle (101a).
ii). A coupling system (1) according to any one of the preceding combinations, in which the main connection assembly (3) comprises a main body (3b) being substantially “C” shaped, and defining the longitudinal cavity (3a) being positioned, shaped and dimensioned to receive the portion of the drawbar (111a) of the traction vehicle (101a).
iii). A coupling system (1) according to any one of the preceding combinations, in which the main connection assembly (3) comprises first and second supports (3c) being operatively connectable with respect to each other, each support (3c) having a main body being substantially “C” shaped, and the supports (3c) being able to be assembled within the main connection assembly (3), to define the longitudinal cavity (3a) being positioned, shaped and dimensioned to receive the portion of the drawbar (111a) of the traction vehicle (101a).
iv). A coupling system (1) according to any one of the preceding combinations, in which the first and second supports (3c) of the main connection assembly (3) are supports being mountable in a fixed manner with respect to the main connection assembly (3).
v). A coupling system (1) according to any of the preceding combinations, in which the main connection assembly (3) comprises a height adjustment sub-assembly (3d) for selectively and adjustably adjusting a height effective (3e) within the longitudinal cavity (3a) of the main connection assembly (3), in order to be able in particular to minimize a free spacing (ex. vertical play) between the longitudinal cavity (3a) and the bar of coupling (111a) of the traction vehicle (101a).
vi). A coupling system (1) according to any one of the preceding combinations, in which the height adjustment subassembly (3d) comprises at least one height adjustment component (3f) (ex. a plate, etc.) being mountable (ex. insertable, etc.) operatively and selectively on a main body of the main connection assembly (3), and within the longitudinal cavity (3a) thereof, so to be able to selectively and adjustably adjust a vertical clearance of the longitudinal cavity (3a).
vii). A coupling system (1) according to any one of the preceding combinations, in which the said at least one height adjustment component (3f) is mountable (ex. insertable, etc.) in an operative and selective manner on the bodies main first and second supports (3c) of the main connection assembly (3) via at least one fastener (11) (ex. screw, rivet, nut, etc.).
viii). A coupling system (1) according to any one of the preceding combinations, in which said at least one height adjustment component (3f) (ex. plate, etc.) is mountable (ex. insertable, etc.) operatively and selectively on the main bodies of the first and second supports (3c) of the main connection assembly (3) by means of at least one pair of fasteners (11) (ex. bolt, screw, rivets, etc.).
ix). A coupling system (1) according to any one of the preceding combinations, in which each attachment (11) of the height adjustment sub-assembly (3d) is insertable into a corresponding hole (13) of the main assembly connection (3).
x). A coupling system (1) according to any one of the preceding combinations, in which each corresponding hole (13) of the main connection assembly (3) is oblong so as to allow additional adjustment in height of the vertical clearance of the longitudinal cavity (3a).
xi). A coupling system (1) according to any of the preceding combinations, in which each attachment (11) is provided with a clamping device (15) (ex. thread, nut, etc.) to clamp in place and in height the attachment within its corresponding hole.
xii). A coupling system (1) according to any of the preceding combinations, in which the pitch adjustment assembly (5) comprises a main body (5a) being operatively mounted to the main body of the main assembly connection (3), and being able to adjust in angle with respect to said main connection assembly (3) by pivoting around the first axis (A) of rotation.
xiii). A coupling system (1) according to any one of the preceding combinations, in which the pitch adjustment assembly (5) comprises at least first and second arms (5b) being operatively connectable one by relative to the other, each arm (5b) having a substantially “L” shaped main body, and each arm (5b) having a front portion being pivotable relative to the first axis (A) of rotation.
xiv). A hitch system (1) according to any of the preceding combinations, wherein said first and second arms (5b) of the pitch adjustment assembly (5) are arms (5b) being removably mountable and pivoting with respect to the main connection assembly (3).
xv). A coupling system (1) according to any one of the preceding combinations, in which the front part of each arm (5b) of the pitch adjustment assembly (5) is also connectable and able to pivot relative to a fixed support (ex. main body (3b) and/or other) corresponding to the main connection assembly (3).
xvi). A coupling system (1) according to any one of the preceding combinations, in which the front part of each arm (5b) of the pitch adjustment assembly (5) is operatively and selectively mountable near a fixed support (ex. main body (3b) and/or other) corresponding to the main connection assembly (3) via at least one fastener (11) (ex. screw, rivet, nut, etc.).
xvii). A coupling system (1) according to any of the preceding combinations, in which said first and second arms (5b) of the pitch adjustment assembly (5) define a space between them allowing the insertion of a connecting rod (17) through a corresponding hole (3g) of a corresponding upper part of the connecting main assembly (3).
xviii). A coupling system (1) according to any one of the preceding combinations, in which the connecting rod (17) is further shaped and dimensioned so as to be insertable into a corresponding hole (111o) of the coupling (111a) of the traction vehicle (101a).
xix). A coupling system (1) according to any one of the preceding combinations, in which the connecting rod (17) comprises an upper flange (17c) being positioned, shaped and dimensioned so as to abut against a circumferential delimitation of the hole (111o) corresponding to the drawbar (111a) of the traction vehicle (101a), to prevent the connecting rod from escaping from said corresponding hole of the drawbar (111a) of the traction vehicle (101a).
xx). A coupling system (1) according to any one of the preceding combinations, in which the upper flange (17c) of the connecting rod is further positioned, shaped and dimensioned so as to abut against a circumferential delimitation of the hole (3g) corresponding to the corresponding upper part of the main connection assembly (3), to prevent the connection rod (17) from escaping from said hole (3g) corresponding to the corresponding upper part of the main connection assembly (3).
xxi). A coupling system (1) according to any one of the preceding combinations, in which the connecting rod (17) further comprises an upper handle (17d) being positioned, shaped and dimensioned so as to allow a user to manually pull on the connecting rod (17) to be able to remove it from the coupling system (1).
xxii). A coupling system (1) according to any one of the preceding combinations, in which the connecting rod (17) comprises a main body (17b) being substantially cylindrical.
xxiii). A coupling system (1) according to any one of the preceding combinations, in which a longitudinal axis (17a) of the connecting rod (17) provides the second axis (B) of rotation to the coupling system (1).
xxiv). A coupling system (1) according to any of the preceding combinations, in which the coupling system (1) comprises a pin (19) extending through the main body (3b) of the main assembly of connection (3), the pin (19) having a longitudinal axis (19a) providing the first axis (A) of rotation to the coupling system (1).
xxv). A coupling system (1) according to any one of the preceding combinations, in which the pin (19) extends transversely with respect to the coupling system (1).
xxvi). A coupling system (1) according to any one of the preceding combinations, in which the connecting rod (17) extends vertically with respect to the coupling system (1).
xxvii). A coupling system (1) according to any one of the preceding combinations, in which the pin (19) is positioned upstream of the connection rod (17), or on the side of the traction vehicle (101a).
xxviii). A coupling system (1) according to any one of the preceding combinations, in which the pin (19) is intended to be positioned above of the drawbar (111a) of the traction vehicle (101a) when the coupling system (1) is in operation.
xxix). A coupling system (1) according to any one of the preceding combinations, in which the coupling system (1) comprises a pivoting shaft (21) being connectable to the pitch adjustment assembly (5), the shaft (21) being capable of pivoting relative to said pitch adjustment assembly (5) around a longitudinal axis (21a) specific to the pivoting shaft (21), the longitudinal axis (21a) of the pivoting shaft (21) providing the third axis (C) of rotation to the coupling system (1).
xxx). A coupling system (1) according to any one of the preceding combinations, in which the pivoting shaft (21) extends longitudinally (ex. axially, etc.) with respect to the coupling system (1).
xxxi). A coupling system (1) according to any one of the preceding combinations, in which the coupling system (1) comprises a power steering accessory (23).
xxxii). A coupling system (1) according to any of the preceding combinations, in which the power steering accessory (23) including sections (23i) being foldable (ex. foldable, etc.) above at least adjustment assembly (5,7,9) and/or the main connection assembly (3) of the coupling system (1).
xxxiii). A coupling system (1) according to any one of the preceding combinations, in which the servo-steering accessory (23) comprises a passage (23o) to allow the passage of the connecting rod.
xxxiv). A coupling system (1) according to any one of the preceding combinations, in which the power steering accessory (23) comprises a section (23i) operative being able to be connected to the drawbar (111a) of the traction vehicle (101a).
xxxv). A coupling system (1) according to any one of the preceding combinations, in which the operative section (23i) of the servo-steering accessory (23) being adapted to be connected to the coupling bar (111a) of the traction vehicle (101a) is provided with a coupling device (25).
xxxvi). A coupling system (1) according to any one of the preceding combinations, in which the coupling device (25) comprises first and second coupling components (25a, 25b) being able to cooperate with each other, as well as with the drawbar (111a) of the traction vehicle (101a).
xxxvii). A coupling system (1) according to any one of the preceding combinations, in which the first and second connection components (25a, 25b) of the connection device (25) respectively comprise at least one male component provided operatively on the operative section (23i) of the power-steering accessory (23) and a corresponding female component operatively provided on the drawbar (111a) of the traction vehicle (101a), the male component of the power steering accessory (23) being selectively and removably insertable into the corresponding female component of the drawbar (111a) of the traction vehicle (101a).
xxxviii). A coupling system (1) according to any one of the preceding combinations, in which the coupling device (25) is adapted to be mounted and tightened against a corresponding peripheral part of the coupling bar (111a) of the vehicle traction (101a).
xxxix). A coupling system (1) according to any one of the preceding combinations, in which the first and second connection components (25a, 25b) of the coupling device (25) comprises respectively first and second tightening components being able to be mounted and tightened against opposite sides of the corresponding peripheral part of the drawbar (111a) of the traction vehicle (101a).
xl). A coupling system (1) according to any one of the preceding combinations, in which the first and second connection components (25a, 25b) of the connection device (25) respectively comprise first and second tightening components being able to be mounted and clamped against the upper and lower sides of the corresponding peripheral part of the drawbar (111a) of the traction vehicle (101a).
xli). A coupling system (1) according to any one of the preceding combinations, in which the first and second connection components (25a, 25b) of the connection device (25) respectively comprise first and second tightening components being able to be mounted and clamped against the left and right sides of the corresponding peripheral part of the drawbar (111a) of the traction vehicle (101a).
xlii). A coupling system (1) according to any one of the preceding combinations, in which the first and second tightening components are capable of being tightened and loosened relative to each other by means of at least a threaded component (27) (ex. bolt and/or any other component and/or corresponding complementary accessory (ex. nut, etc.)).
xliii). A coupling system (1) according to any one of the preceding combinations, in which the first and second tightening components are capable of being tightened and loosened relative to each other by means of at least a pair of threaded components (27) (ex. bolt(s) and/or any other corresponding component(s) and/or complementary accessory(ies) (ex. nut(s), etc.)), each threaded component (27) being provided on either side of the corresponding peripheral part of the drawbar (111a) of the traction vehicle (101a).
xliv). A coupling system (1) according to any one of the preceding combinations, in which at least one of the first and second clamping components comprises at least one groove (29) to receive a portion of a corresponding threaded component (27).
xlv). A coupling system (1) according to any one of the preceding combinations, in which each of the first and second tightening components comprises at least one groove (29) for receiving a portion of a corresponding threaded component (27).
xlvi). A coupling system (1) according to any one of the preceding combinations, in which each groove (29) of each tightening component is elongated in order to allow movement and corresponding positioning adjustment of the threaded component (27) corresponding to the within said groove (29).
xlvii). A coupling system (1) according to any one of the preceding combinations, in which the coupling device (25) is pivotally mounted on a distal operative section (23i) of the power steering accessory (23).
xlviii). A coupling system (1) according to any one of the preceding combinations, in which at least one component (25a) of the coupling device (25) is pivotally mounted on a pivot axis (31) corresponding to said section (23i) distal operative part of the power steering accessory (23).
xlix). A kit with corresponding components for assembling a coupling system (1) according to any of the preceding combinations.
l). A vehicle (101) provided with a coupling system (1) according to any one of the preceding combinations.
li). An arrangement of traction vehicle (101a) and trailed vehicle (101b), said arrangement of vehicles being provided with a coupling system (1) according to any one of the preceding combinations.

Of course, several modifications and/or other alternatives and/or other technical/mechanical equivalents could be made to this system and/or to the components and/or to the corresponding steps thereof, without departing from the present invention, as obvious to a person versed in the field.

As can now be better appreciated in view of the foregoing, the present invention is particularly advantageous insofar as it makes it possible to provide all the principles and advantages of the operation of a universal joint but, by offsetting the axis of the pitch towards the front, which makes it possible in particular, and advantageously, in an additional and innovative way, to better support the imposing vertical loads of certain machines trailed on the drawbar of the tractor, for example. Moreover, the present invention is particularly advantageous also insofar as it allows greater flexibility in terms of “positioning” and/or “adjustment” with regard to the “connection” of the power steering accessory. to the drawbar, regardless of the shape and/or dimensions that the latter may have, etc.

As can now also be better appreciated, the present invention is also advantageous insofar as it makes it possible to couple a traction vehicle (ex. a tractor, etc.) to a trailed vehicle (ex. a trailer, a spreader, etc.), and to be able to do it in a faster, simpler, more precise, more efficient, more economical, more reliable, more adjustable, more versatile, more adaptable, more durable, more versatile, more desirable, and/or in an improved way, of what is possible with the current way of doing things, in particular by providing greater degrees of freedom with regard to movements and/or angle adjustments being possible (for larger ranges of angles being possible, etc.).

Finally, and according to the present invention, the coupling equipment (and/or resulting system, etc.) and its corresponding components are preferably made of substantially rigid materials, such as metallic materials (stainless steel, titanium, etc.), hardened polymers, composite materials, and/or any other suitable material, while the other components of the system according to the present invention, in order to obtain the advantages discussed above, can be made of any other suitable material, such as polymeric materials (plastic, rubber, etc.), and/or any other suitable material, depending on the particular applications for which the system is designed and the various parameters involved, as obvious to a person versed in the art.

Although the present invention has been previously explained through preferred embodiments thereof, it should be understood that any modification to these preferred embodiments is not considered to change or alter the nature and scope of the present invention. Indeed, the attached claim(s) must not be limited in its (their) scope(s) by the preferred embodiments illustrated in the examples, but must receive the broadest interpretation that is consistent with the description as a whole.

1. A coupling system (1), for coupling a traction vehicle (101a) to a towed vehicle (101b) being pulled by the traction vehicle (101a), the coupling system (1) comprising:
a main connection assembly (3) defining a longitudinal cavity (3a) being positioned, shaped and sized to receive a portion of a drawbar (111a) of the traction vehicle (101a);
a pitch adjustment assembly (5) being operatively mounted to the main connection assembly (3), and being able to adjust in angle with respect to said main connection assembly (3) by pivoting about a first axis (A) of rotation;
a yaw adjustment assembly (7) being operatively mounted to the main connection assembly (3), and being able to adjust in angle with respect to said main connection assembly (3) by pivoting around a second axis (B) of rotation; and
a roll adjustment assembly (9) being operatively mounted to the pitch adjustment assembly (5), and being angle adjustable relative to said pitch adjustment assembly (5) by pivoting about a third axis (C) of rotation;
wherein the first axis (A) of rotation is positioned upstream of the second axis (B) of rotation, namely on the side of the traction vehicle (101a).

2. A coupling system (1) according to claim 1, wherein the main connection assembly (3) comprises a main body (3b) being substantially “C” shaped, and defining the longitudinal cavity (3a) being positioned, shaped and sized to receive the drawbar portion (111a) of the towing vehicle (101a).

3. A coupling system (1) according to claim 1 or 2, wherein the main connection assembly (3) comprises first and second supports (3c) being operatively connectable relative to each other, each support (3c) having a main body being substantially “C” shaped, and the supports (3c) being able to be assembled within the main connection assembly (3), to define the longitudinal cavity (3a) being positioned, shaped and dimensioned to receive the drawbar portion (111a) of the traction vehicle (101a).

4. A coupling system (1) according to claim 3, wherein the first and second supports (3c) of the main connection assembly (3) are supports being mountable in a fixed manner relative to the main assembly connection (3).

5. A coupling system (1) according to any one of claims 1-4, wherein the main connection assembly (3) comprises a height adjustment sub-assembly (3d) for selectively adjusting and adjustable an effective height (3e) within the longitudinal cavity (3a) of the main connection assembly (3), in order to be able in particular to minimize free spacing, namely a vertical play, between the longitudinal cavity (3a) and of the drawbar (111a) of the traction vehicle (101a).

6. A coupling system (1) according to claim 5, in which the height adjustment subassembly (3d) comprises at least one height adjustment component (3f) being operatively and selectively mountable on a main body of the main connection assembly (3), and within the longitudinal cavity (3a) thereof, so as to be able to selectively and adjustably adjust a vertical clearance of the longitudinal cavity (3a).

7. A coupling system (1) according to claim 6, wherein said at least one height adjustment component (3f) is operatively mountable and selectively on the main bodies of the first and second supports (3c) of the main connection assembly (3) by means of at least one fastener (11).

8. A coupling system (1) according to claim 6 or 7, wherein said at least one height adjustment component (3f) is operably and selectively mountable on the main bodies of the first and second supports (3c) of the main connection assembly (3) via at least one pair of fasteners (11).

9. A coupling system (1) according to claim 8, wherein each fastener (11) of the height adjustment sub-assembly (3d) is insertable into a corresponding hole (13) of the main connection assembly (3).

10. A coupling system (1) according to claim 9, wherein each hole (13) corresponding to the main connection assembly (3) is oblong so as to allow additional adjustment in height of the vertical clearance of the cavity longitudinal (3a).

11. A coupling system (1) according to any one of claims 7-10, in which each fastener (11) is provided with a clamping device (15) to clamp the fastener in place and in height within its corresponding hole.

12. A coupling system (1) according to any one of claims 1-11, in which the pitch adjustment assembly (5) comprises a main body (5a) being operatively mounted to the main body of the main connection assembly (3), and being able to adjust in angle relative to said main connection assembly (3) by pivoting around the first axis (A) of rotation.

13. A coupling system (1) according to any one of claims 1-12, wherein the pitch adjustment assembly (5) comprises at least first and second arms (5b) being operatively connectable with respect to each other, each arm (5b) having a substantially “L” shaped main body, and each arm (5b) having a front part being capable of pivoting with respect to the first axis (A) of rotation.

14. A coupling system (1) according to claim 13, wherein said first and second arms (5b) of the pitch adjustment assembly (5) are arms (5b) being removably mountable and pivotally with respect to the main connection assembly (3).

15. A coupling system (1) according to claim 13 or 14, wherein the front part of each arm (5b) of the pitch adjustment assembly (5) is further connectable and pivotable relative to a corresponding fixed support of the main connection assembly (3).

16. A coupling system (1) according to any one of claims 13-15, wherein the front part of each arm (5b) of the pitch adjustment assembly (5) is operatively and selectively mountable to a corresponding fixed support of the main connection assembly (3) by through at least one fastener (11).

17. A coupling system (1) according to any one of claims 13-16, wherein said first and second arms (5b) of the pitch adjustment assembly (5) define a space between them allowing the insertion of a connecting rod (17) through a corresponding hole (3g) of a corresponding upper part of the main connection assembly (3).

18. A coupling system (1) according to claim 17, in which the connecting rod (17) is further shaped and dimensioned so as to be insertable into 31 a hole (111o) corresponding to the drawbar (111a) of the traction vehicle (101a).

19. A coupling system (1) according to claim 18, wherein the connecting rod (17) comprises an upper flange (17c) being positioned, shaped and dimensioned so as to abut against a circumferential delimitation of the hole (111o) corresponding to the drawbar (111a) of the traction vehicle (101a), to prevent the connecting rod from escaping from said corresponding hole of the drawbar (111a) of the traction vehicle (101a).

20. A coupling system (1) according to claim 19, wherein the upper flange (17c) of the connecting rod is further positioned, shaped and dimensioned so as to abut against a circumferential delimitation of the hole (3g) corresponding of the corresponding upper part of the main connection assembly (3), to prevent the connection rod (17) from escaping from said corresponding hole (3g) of the corresponding upper part of the main connection assembly (3).

21. A coupling system (1) according to any one of claims 17-20, wherein the connecting rod (17) further includes an upper handle (17d) being positioned, shaped and sized to allow a user to manually pull the connecting rod (17) to remove it from the system coupling (1).

22. A coupling system (1) according to any one of claims 17-21, wherein the connecting rod (17) has a main body (17b) being substantially cylindrical.

23. A coupling system (1) according to any one of claims 17-22, in which a longitudinal axis (17a) of the connecting rod (17) provides the second axis (B) of rotation to the coupling system (1).

24. A coupling system (1) according to any one of claims 1-23, wherein the coupling system (1) comprises a pin (19) extending through the main body (3b) of the main connection assembly (3), the pin (19) having a longitudinal axis (19a) providing the first axis (A) of rotation to the coupling system (1).

25. A coupling system (1) according to claim 24, wherein the pin (19) extends transversely relative to the coupling system (1).

26. A coupling system (1) according to any preceding claims, wherein the connecting rod (17) extends vertically relative to the coupling system (1).

27. A coupling system (1) according to any one of the preceding claims, wherein the pin (19) is positioned upstream of the connecting rod (17), or on the side of the traction vehicle (101a).

28. A coupling system (1) according to claim 27, wherein the pin (19) is intended to be positioned above the coupling bar (111a) of the traction vehicle (101a) when the system of coupling (1) is in operation.

29. A coupling system (1) according to any one of claims 1-28, wherein the hitch system (1) comprises a pivoting shaft (21) being connectable to the pitch adjustment assembly (5), the shaft (21) being capable of pivoting with respect to said pitch adjustment assembly (5) around a longitudinal axis (21a) specific to the pivoting shaft (21), the longitudinal axis (21a) of the pivoting shaft (21) providing the third axis (C) of rotation to the coupling system (1).

30. A coupling system (1) according to claim 29, wherein the pivoting shaft (21) extends longitudinally relative to the coupling system (1).

31. A coupling system (1) according to any one of claims 1-30, wherein the coupling system (1) comprises a power steering accessory (23).

32. A coupling system (1) according to claim 31, wherein the power steering accessory (23) including sections (23i) being foldable above at least adjustment assembly (5,7,9) and/or the main connection assembly (3) of the coupling system (1).

33. A coupling system (1) according to claim 31 or 32, wherein the power steering accessory (23) has a passage (23o) to allow the passage of the connecting rod.

34. A coupling system (1) according to any one of claims 31-33, wherein the power steering accessory (23) comprises an operative section (23i) being able to connect to the steering bar. coupling (111a) of the traction vehicle (101a).

35. A coupling system (1) according to claim 34, wherein the operative section (23i) of the power steering accessory (23) being able to connect to the hitch bar (111a) of the vehicle traction (101a) is provided with a connecting device (25).

36. A coupling system (1) according to claim 35, in which the coupling device (25) comprises first and second coupling components (25a, 25b) being able to cooperate with each other, as well as with the drawbar (111a) of the traction vehicle (101a).

37. A coupling system (1) according to claim 36, in which the first and second coupling components (25a, 25b) of the coupling device (25) respectively comprise at least one male component operatively provided on the section (23i) of the power steering accessory (23) and a corresponding female component operatively provided on the drawbar (111a) of the traction vehicle (101a), the male component of the servo-direction accessory (23) being selectively and removably insertable into the corresponding female component of the drawbar (111a) of the traction vehicle (101a).

38. A coupling system (1) according to any one of claims 35-37, wherein the coupling device (25) is adapted to be mounted and clamped against a corresponding peripheral part of the hitch bar (111a) of the traction vehicle (101a).

39. A coupling system (1) according to claim 36, in which the first and second connecting components (25a, 25b) of the connecting device (25) respectively comprise first and second clamping components being adapted to be mounted and clamped against opposite sides of the corresponding peripheral part of the drawbar (111a) of the traction vehicle (101a).

40. A coupling system (1) according to claim 36 or 39, in which the first and second connecting components (25a, 25b) of the connecting device (25) respectively comprise first and second clamping components being able to be mounted and clamped against upper and lower sides of the corresponding peripheral part of the drawbar (111a) of the traction vehicle (101a).

41. A coupling system (1) according to claim 36 or 39, in which the first and second connecting components (25a, 25b) of the connecting device (25) respectively comprise first and second clamping components being able to be mounted and clamped against left and right sides of the corresponding peripheral part of the drawbar (111a) of the traction vehicle (101a).

42. A coupling system (1) according to any one of claims 39-41, wherein the first and second clamping components are capable of being tightened and loosened with respect to each other through at least one threaded component (27).

43. A coupling system (1) according to any one of claims 39-41, wherein the first and second clamping components are capable of being tightened and loosened relative to each other through at least one pair of threaded components (27), each threaded component (27) being provided on either side of the corresponding peripheral part of the drawbar (111a) of the traction vehicle (101a).

44. A coupling system (1) according to claim 43, wherein at least one of the first and second clamping components comprises at least one groove (29) for receiving a portion of a threaded component (27) corresponding.

45. A coupling system (1) according to claim 43, wherein each of the first and second clamping components comprises at least one groove (29) for receiving a portion of a threaded component (27) corresponding.

46. A coupling system (1) according to claim 44 or 45, in which each groove (29) of each tightening component is elongated in order to allow a displacement and corresponding positioning adjustment of the corresponding threaded component (27) within said groove (29).

47. A coupling system (1) according to any one of claims 35-46, wherein the coupling device (25) is pivotally mounted to a distal operative section (23i) of the power steering attachment (23).

48. A coupling system (1) according to any one of claims 35-47, wherein at least one component (25a) of the coupling device (25) is pivotally mounted on a corresponding pivot axis (31) of said distal operative section (23i) of the power steering accessory (23).

49. A kit with corresponding components for assembling a coupling system (1) according to any one of claims 1-48.

50. A vehicle (101) provided with a coupling system (1) according to any one of claims 1-48.

51. An arrangement of traction vehicle (101a) and trailed vehicle (101b), said arrangement of vehicles being provided with a coupling system (1) according to any one of claims 1-48.
